(19) United States
(12) Patent Application Publication
(10) Pub. No.: US 2009/0313134 A1
(43) Pub. Date: Dec. 17, 2009

(54) RECOVERY OF TRANSACTION INFORMATION

(76) Inventors: Patrick Faith, Pleasanton, CA (US); Krishna Prasad Koganti, Cupertino, CA (US); Lori D. Van Deloo, Los Altos, CA (US); Taylor Montgomery Mason, Wilmington, DE (US); Kim Steele, Aldie, VA (US); Kevin Weller, San Anselmo, CA (US); Ayman Hammad, Pleasanton, CA (US); Kevin Eric Wong, Sausalito, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/433,086

(22) Filed: Apr. 30, 2009

Related U.S. Application Data
(60) Provisional application No. 61/050,095, filed on May 2, 2008.

(51) Int. Cl. G06Q 20/00; G06Q 30/00; G06Q 40/00; G06F 15/16

(52) U.S. Cl. 705/26; 705/35; 705/41; 705/44; 709/206

(57) ABSTRACT

Online transaction processing over a communication network involves receiving a transaction input comprising an authorization request message for a transaction conducted over a communication network between a consumer and a merchant using a portable consumer device having a memory, wherein the authorization request message contains data comprising a transaction total amount for the transaction and additional information not stored in the memory of the portable consumer device and related to the transaction. Issuer authorization processing is performed in response to the authorization request message data, and a decision output is produced in response to the transaction input and the issuer authorization processing. Thus, a decision output is produced in an efficient manner using additional information for the issuer authorization processing, and the additional information reduces the likelihood of declining a transaction that should otherwise be authorized.

### CROSS-REFERENCES TO RELATED APPLICATIONS

This application claims the benefit of U.S. Provisional Application Ser. No. 61/050,095 entitled “Recovery of Transaction Information”, by Patrick Faith, et al., filed May 2, 2008. Priority of the filing date is hereby claimed, and the disclosure of the Provisional Application is hereby incorporated by reference.

This application incorporates by reference for all purposes the entire contents of the following: (1) U.S. Pat. No. 6,119,103 issued Sep. 12, 2000 entitled “Financial Risk Prediction Systems and Methods Therefor” to C. Basch et al.; (2) U.S. Pat. No. 6,018,723 issued Jan. 25, 2000 entitled “Method and Apparatus for Pattern Generation” to K. Siegel et al.; (3) U.S. Pat. No. 6,658,393 issued Dec. 2, 2003 entitled “Financial Risk Prediction Systems and Methods Therefor” to C. Basch et al.; (4) U.S. Patent Application Publication No. US2005/0149455 published Jul. 7, 2005 entitled “Method and System for Providing Advanced Authorization” to B. Bruesewitz et al.; (5) U.S. Patent Application Publication No. US 2002/0194503 published Dec. 19, 2002, entitled “Distributed Quantum Encrypted Pattern Generation and Scoring” to P. Faith et al.; (6) U.S. Patent Application Publication No. US2003/0233292 published Dec. 18, 2003 entitled “Method and System for Facilitating Electronic Dispute Resolution” to D. Richey et al.; (7) U.S. patent application Ser. No. 11/763,240 filed Jun. 14, 2007 entitled “Consumer Authentication System and Method” to A. Hammad and P. Faith.

### BACKGROUND

In a conventional consumer card payment transaction at a retail outlet, a cardholder presents a merchant with a portable consumer device such as a credit card to pay for goods or services. This type of transaction can be characterized as a “card present” transaction in which the merchant can confirm the cardholder as having possession of the card being used.

Any potential problems that might arise during the “card present” merchant processing can typically be resolved with telephone communication between the consumer and/or merchant, and a representative of the issuer of the credit card. The issuer can then obtain sufficient extra information to make a decision regarding authorization. If, for example, the cardholder wants to purchase a computer that costs more than $3000, the issuer may want to verify the consumer's identity before approving the transaction. Thus, in the “card present” scenario, where the card is available to the merchant, the representative of the issuer may speak directly with the consumer (or vice-versa) to request more information to thereby authenticate the consumer. Such processing is known as “referral” processing.

While referral processing works in face-to-face credit card transactions, referral processing protocols have not been developed for transactions taking place with merchants over a communication network, such as telephone orders or Internet transactions. Purchases are increasingly being performed online, such as over the Internet via sites on the World Wide Web using a Web browser application. Online merchants typically maintain a purchase Web site to which consumers can navigate. When a consumer wishes to make an online purchase over the Internet, the consumer will direct their browser to the Web site of the online merchant, and the browser will typically display a Web page having forms for the input of transaction data. The online merchant will collect the data from the consumer to process the transaction and will forward data to the issuer for approval. If the issuer approves the transaction, the transaction will be completed and the order will be shipped to the consumer. The data that issuers typically receive from online merchants comprises consumer name, account number, and total amount of the transaction.

If the purchase being made by a consumer is what might be considered a risky purchase (e.g., if the total purchase amount is over $3000), there are currently few, if any, effective online referral processing protocols that will allow the issuer to gather further information from the consumer so that the issuer can potentially approve the transaction. Thus, in most instances, the issuer will simply decline the transaction because there is no current means to gather enough extra information to allow the issuer to approve the transaction. Declining transactions that should otherwise be authorized is bad for the issuer, because the issuer would like to authorize as many transactions as possible. It is also bad for the consumer, because the consumer may be frustrated by the inability to complete the intended transaction, despite being in good standing with the issuer (e.g., the user is authentic and has sufficient credit).

Embodiments of the invention address the above problems and other problems, individually and collectively.

### SUMMARY

In accordance with the invention, transactions over communication networks relating to accounts administered by an issuer involve receiving a transaction input comprising an authorization request message for a transaction conducted over a communication network between a consumer and a merchant using a portable consumer device having a memory, wherein the authorization request message contains data comprising a transaction total amount for the transaction and additional information not stored in the memory of the portable consumer device and related to the transaction. Issuer authorization processing is performed in response to the authorization request message data, and a decision output is produced in response to the transaction input and the issuer authorization processing. Thus, a decision output is produced in an efficient manner using additional information for the issuer authorization processing, and the additional information reduces the likelihood of declining a transaction that should otherwise be authorized.

In additional aspects, risk assessment processing is performed in accordance with the additional information, wherein performing risk assessment processing includes determining if the additional information in the authorization request message data indicates a risk level for the transaction that is commensurate with approving the transaction. The transaction is authorized if the risk assessment processing determines that the risk level for the transaction is satisfactory for approval.

The disclosed technique improves the likelihood of successfully resolving any problems that arise during a transaction session using a portable consumer device. The portable consumer device can take many forms, including credit cards, smart cards, payment tokens, Web-enabled PDA's, telephones, and other processing devices through which a consumer can communicate with a merchant and conclude transactions. As used herein, “using” a portable consumer device includes the “card present” and also online or “card not present” transactions. That is, the techniques described herein have application to scenarios where the merchant has access to the portable consumer device, as well as scenarios where the merchant is online (e.g. telephone or Internet) and the portable consumer device is not available. In this way, the transaction processing described herein recovers information that is often in the possession of the merchant but which is not currently available to backend processing, and therefore the disclosed processing can help resolve problems with the transaction, resulting in increased online sales volume for merchants and an improved buying experience for consumers.

The additional information provided to the issuer in the authorization request message can comprise a variety of information that the issuer finds helpful in performing risk assessment processing and coming to an approval decision. For example, the additional information may comprise one or more of the following: product identification information; product quantity; consumer shipping address; consumer contact information such as telephone and residence address; network address information; portable consumer device identification such as device identification number; and historical transaction data for other transactions. The additional information also may relate to a reward credential or promotional program.

The risk assessment processing can comprise an iterative process that may include either or both of challenge-response processing and additional requests for information. The iterative processing can involve serial challenge-responses and requests for information in which the consumer response to each request determines whether an additional request for information will be generated.

Other objects and advantages of the present invention will be apparent to one of ordinary skill in the art upon review of the detailed description of the present invention and the included figures.

### BRIEF DESCRIPTION OF THE DRAWINGS

FIG. 1 is a block diagram representation of an online transaction processing system constructed in accordance with the present invention.

FIG. 2 is a flow diagram representation of processing in the FIG. 1 system.

FIG. 3 is a flow diagram representation of the data provided between the purchase, online merchant, and backend processing for the FIG. 1 system.

FIG. 4 is a block diagram depiction of the backend processing for online transactions in the FIG. 1 system, where all the consumer transaction information needed for an approval decision is received from the merchant.

FIG. 5 is a block diagram depiction of the backend processing for online transactions in the FIG. 1 system, where the consumer transaction information needed for an approval decision is requested directly from the consumer.

FIG. 6 is a flow diagram of the processing operations performed by the FIG. 1 system.

FIG. 7 is a flow diagram of the processing by the FIG. 4 configuration to process the additional information and further additional information by the FIG. 1 system.

FIG. 8 is a flow diagram of the processing by the FIG. 5 configuration to perform risk assessment processing.

FIG. 9 is a block diagram of an exemplary portable consumer device for use in the FIG. 1 system.

FIG. 10 is a plan view of a second type of portable consumer device for use in the FIG. 1 system.

### DETAILED DESCRIPTION

Embodiments of the invention can increase the likelihood that a transaction between a consumer and a merchant will proceed to completion. A transaction input comprising an authorization request message is received and is subjected to issuer authorization processing and subsequent authentication processing that produces a decision output. Improving the likelihood of completion can be achieved by providing additional information to the issuer “up front” with the authorization request message, so that the issuer can determine whether or not to authorize the transaction. If the additional information is provided at the front end of a transaction, with the authorization request message, then additional referral processing may not be needed to generate an authorization approval decision. Processing of the additional information comprises a feedback loop for improved assessment between receipt of the transaction input and the decision output. Additionally or alternatively, challenge questions or requests for further additional information and the like may be provided to a consumer in response to situations where the issuer may decide that the transaction has reached a predetermined risk level that warrants such requests, providing improved feedback in connection with the decision output.

Many of the specific embodiments described below relate to online purchase transactions. Embodiments of the invention are not limited thereto, and may apply to situations where a consumer may be face-to-face with a merchant. Embodiments of the invention may also relate to other types of transactions, such as money transfer transactions and health care transaction processing.

In some embodiments of the invention, an authorization request message for an online network purchase transaction is processed such that problems that arise during the online session of the consumer at the online merchant Web site are more likely to be successfully resolved. The increased resolution success results from ensuring that the backend transaction processing, comprising the acquirer/issuer processing, is provided with additional information in the authorization request message. The additional information can comprise information that is necessary to make most approval decisions and that is missing from conventional transaction data received at the backend systems for processing online transactions. The additional information that is provided in the authorization request message may comprise information that is not stored in a computer readable medium or memory in the portable consumer device being used in connection with the transaction.

For example, the additional information can comprise information such as the consumer's phone number(s), e-mail address, IP network address, transaction history, local time, shipping address, reward credential (e.g., a coupon code or other promotional element), and the like. Such additional information is typically not stored in the memory of the portable consumer device, and may be sent to an issuer along with conventional authorization request message information. Once the backend system receives this additional information, there may be enough information for the issuer to approve the transaction and additional referral processing may not be needed.

The portable consumer device can take many forms, including credit cards, smart cards, payment tokens, Web-enabled PDA's, telephones, and other processing devices through which a consumer can communicate with a merchant and conclude transactions. As used herein, using a portable consumer device includes the card present and also online (card not present) transactions. For example, a consumer completing a telephone transaction may use a portable consumer device comprising a credit card by providing verbal information relating to the card and the consumer. A consumer completing an Internet-based transaction may use a portable consumer device comprising a credit card by visiting an online merchant Web site with a computer to make a selection and provide consumer account information for the transaction. A consumer completing an Internet-based transaction may use a portable consumer device comprising a Web-enabled PDA device or a smart phone to make a purchase selection and enter information at a merchant Web site. Each of these transactions may be regarded as involving online card-not-present communications, in that the portable consumer device is not in the physical presence of the merchant.

The additional information may include an identification number of the communication device with which the user is communicating over the network to conclude the transaction. For example, if the transaction is being completed with a Web-enabled PDA or a smart phone, then the additional information may include an identification number of the PDA or phone itself. If the transaction is being completed over the Internet via a computer such as a desktop or laptop computer, so that the consumer is likely entering data for the transaction at a Web site, then the identification number of the communication device may be the media access control address (MAC address) of the computer or the Internet Protocol network address (IP address) of the user or other similar information. In the case of the computer-based Web site transaction, the consumer is using his or her credit card (portable consumer device) account information in completing the transaction.

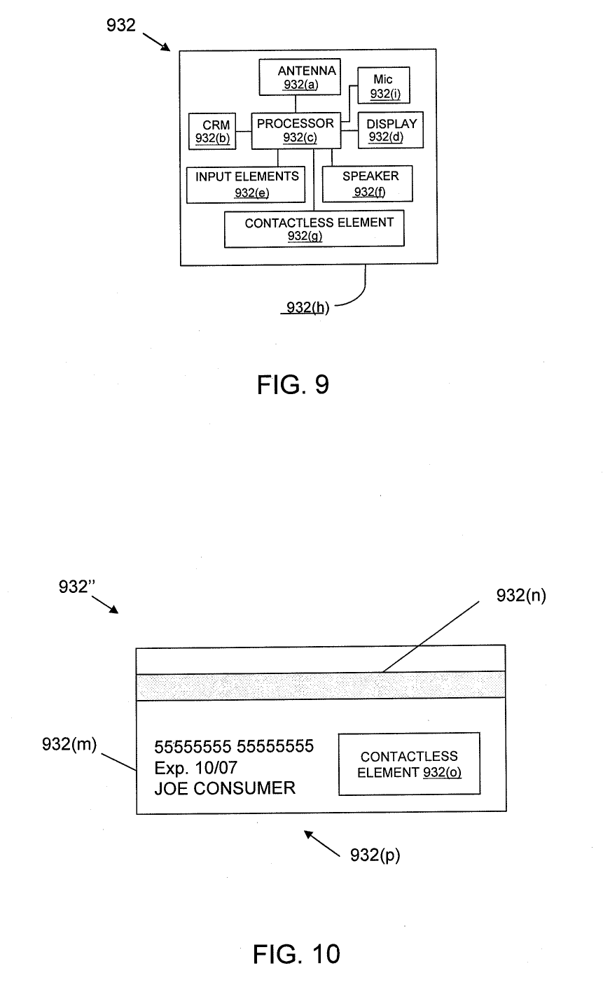

Further description is provided below in connection with FIGS. 9 and 10 for exemplary portable consumer devices and other components of a system that provides functionality in accordance with the invention.

The techniques described herein also have application to scenarios where the merchant has access to the portable consumer device. For example, a consumer may present a portable consumer device such as a credit card to a retailer. In accordance with the invention, the retail merchant can provide the additional information to the issuer in the authorization request message, thereby increasing the likelihood that sufficient information will be transmitted “up front” so that the need for referral processing is decreased and issuer authorization will be approved.

In some other embodiments, an online purchase transaction system illustrated in the drawings receives conventional transaction data, typically comprising merchant identity, the consumer account identity, and the total amount of the transaction, with the additional information. The system may determine if such conventional transaction data, along with the additional information, indicates a risk level that is commensurate with approving the transaction. That is, if no elevated risk level is determined and the risk is satisfactory, then the transaction is approved and the online purchase transaction session continues to successful conclusion.

For online purchases in which the transaction data including the additional information indicates an elevated risk level, the system may perform additional risk assessment processing using further additional information. In one configuration, the risk assessment processing receives the further additional information from the online merchant. No additional communications with the consumer are necessary for the processing of the further additional information and for producing an approval/decline decision for the online transaction. In an alternate configuration, the further additional information is received directly from the consumer, bypassing the online merchant in the communication. In this way, the merchant is not burdened with additional operations or with supporting additional communications. This configuration is also suitable for redeeming reward credentials or other special promotional elements, or other password-dependent processing. In both of these configurations, the system improves the likelihood of successfully resolving any problems that arise during the online transaction session because additional information that would be available from referral processing in the “card present” situation is obtained in the online situation. In addition to consumer transaction information, additional data can be reviewed in the form of consumer historical information. Such historical information can reveal spending patters that can be compared to the present transaction, to either confirm consistent behavior or warn of a change in patterns that might indicate fraudulent activity.

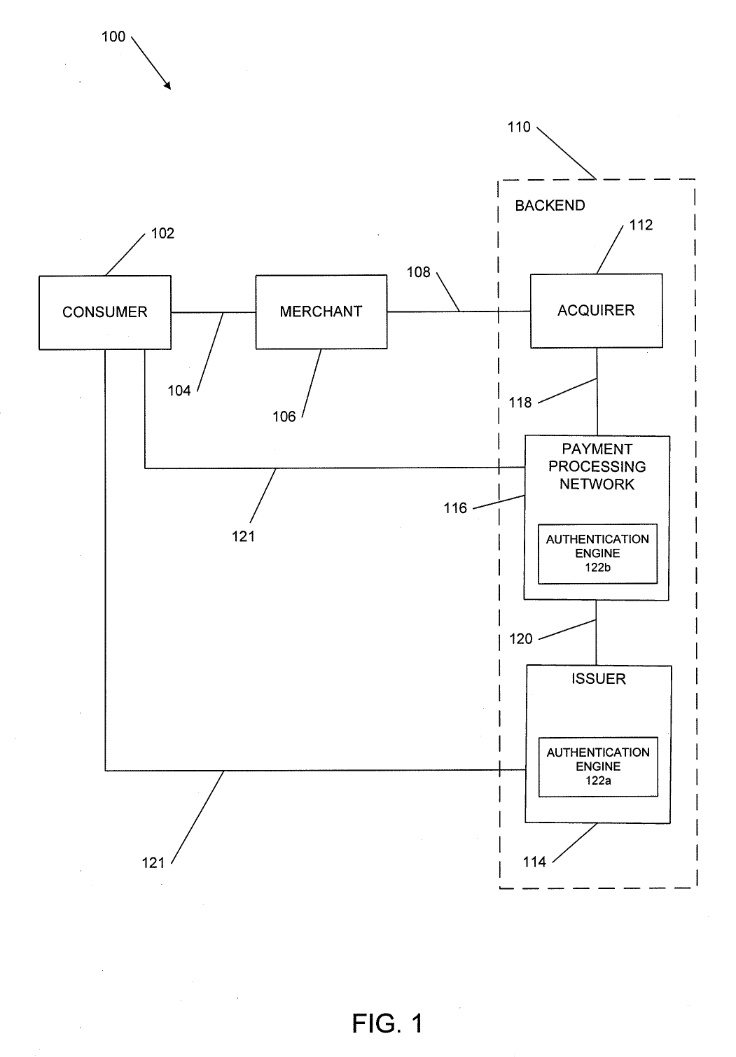

FIG. 1 is a block diagram representation of an online transaction processing system 100 constructed in accordance with an embodiment of the present invention. In the system, a consumer 102 initiates a transaction session over a connection 104 (e.g., which may be part of a communication network) with a merchant 106. The consumer-merchant connection 104 is referred to herein as the purchase channel. The purchase channel between the consumer and the merchant may comprise a connection such as a telephone line connection or a computer network connection, or may be a physical presence (i.e., card present).

The merchant 106 provides transaction data over a communications network 108 to backend processing 110. The backend processing involves an acquirer 112 processing the transaction in conjunction with an issuer 114 communicating over a payment processing network 116. Intervening communication lines 118 connect the acquirer 112 to the network 116 and lines 120 connect the network 116 to the issuer 114. The merchant 106 provides an authorization request message over the connection 108 to the backend processing 110 to obtain approval for the transaction. In accordance with the invention, the authorization request message includes the additional information. Additional communication lines 121 may be provided for communication from the consumer directly to processing elements 114, 116 of the backend processing 110, as described further below.

The issuer 114 may include an authentication engine 122a and the payment processing network 116 may include an authentication engine 122b. The two authentication engines 122a, 122b of FIG. 1 perform processing in accordance with the authorization request message and additional information, and in some configurations (described below) have the capability of direct communications with the consumer 102 over a connection other than through the purchase channel 104. The two illustrated authentication engines 122a, 122b may comprise components that act in concert together, or one authentication engine or the other 122a, 122b may be absent from the system, such that the authentication processing described herein is performed completely by either the issuer 114 or the payment processing network 116. Those skilled in the art will appreciate that the acquirer 112, issuer 114, and payment processing network 116 can comprise separate entities, or can be combined into sub-entities or into a single entity, depending on the account type of the consumer 102 and the identities of the merchant, acquirer, and issuer.

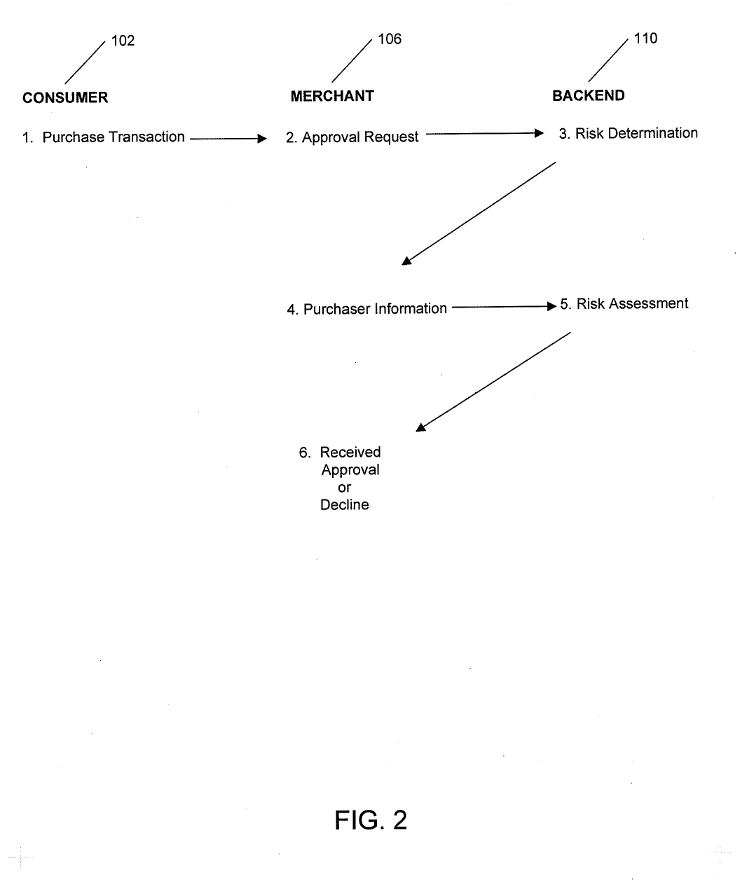

FIG. 2 is a flow diagram representation of operations comprising the processing in the FIG. 1 system, as between the consumer 102, merchant 106, and backend 110. The processing of the system begins with a consumer initiating a transaction session, such as via a Web browser over the Internet. This initial action is indicated by operation “1” in FIG. 2. During the transaction session, the transaction operation (1) will involve the consumer providing data requested by the merchant. For a purchase transaction, such data typically includes a product identification number, a quantity number, unit price, consumer account data, and consumer identification data such as correspondence address, shipping address, and other contact information. When the merchant receives this information, it assembles an authorization request message for the purchase transaction (at operation “2”).

At the backend processing 110, the conventional transaction data can be used to identify a transaction with an elevated risk level. Such conventional transaction data usually includes merchant identity, the consumer account identity, and the total purchase amount of the transaction. In accordance with the invention, additional information is provided with the authorization request message of the system 100 (FIG. 1). Increased risk level can be indicated by, for example, a consumer account that is overdue, a merchant with a high fraud exposure, or a transaction amount that exceeds satisfactory levels. If no increased risk factors are identified from the authorization request message, then the transaction can be approved. If increased risk factors are identified from the transaction data, then the backend processing can obtain further additional information (“4”).

The further additional information comprises consumer transaction information that can be obtained from the merchant. Such information can include more detailed information about the transaction itself, such as particular items in the purchase and the number of items being purchased, or the address to which products are being shipped, or the location from which the order is being placed. The items in the purchase may be identified by a product identification number, also called a “stock keeping unit” or SKU, a common identification scheme used by most retailers and merchants to identify their particular products for sale.

With the additional consumer information from “4” in the authorization request message of the system 100, the backend processing 110 will have available the SKU information and the units purchased information that can be used for improved risk assessment processing (“5”) to identify, for example, whether an inordinate number of products are being ordered or if questionable items are being ordered, indicating potential fraudulent activity such as using a stolen card. For example, a purchase involving many pairs of athletic shoes is one with an inordinate number of units purchased, because most persons by very few pairs of shoes in any single transaction. If dozens of shoes are being purchased, the online purchase might indicate a stolen card purchase for later resale. Similarly, the purchase of a product having a SKU that is identified with fraudulent or questionable use can be identified as potentially fraudulent, or conversely as having a reduced likelihood of fraud. This additional information is used to perform risk assessment. Once the risk assessment processing is performed, the backend processing will provide an approve or decline outcome, and will communicate that decision to the online merchant (at “6”).

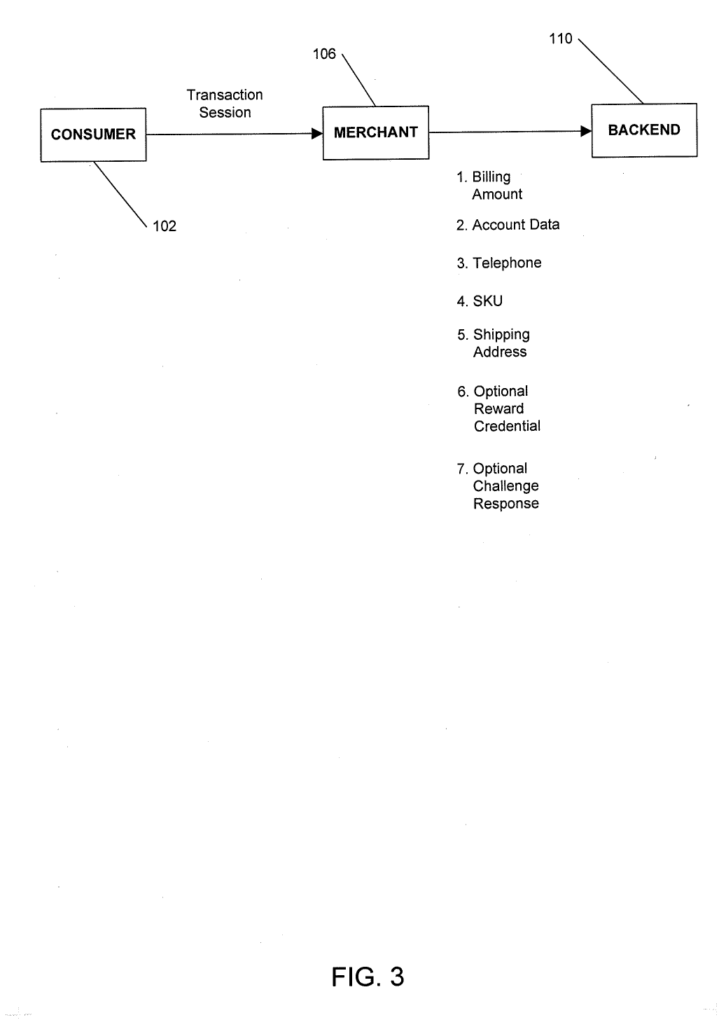

FIG. 3 is a flow diagram representation of the data provided between the consumer 102, merchant 106, and backend processing 110 for the FIG. 1 system. FIG. 3 shows that an online consumer initiates an online transaction session with a merchant. The merchant receives the consumer order and generates an authorization request message, which will be sent to the backend 110 for processing. FIG. 3 shows that, in accordance with an embodiment of the present invention, the information available to the backend includes billing account information and account data, such as might be available from conventional systems, and also provides additional consumer transaction information including consumer telephone number, transaction SKU data, consumer shipping address, optional reward credential information such as for special promotions, and optional challenge/response feedback from the consumer. The additional data items of the consumer transaction information over the conventional transaction data can be transmitted from the merchant to the backend via data protocols that are configured to accommodate the additional data items. In this way, the data gathered by the merchant is not lost to the backend, but is recovered from the merchant, who, as noted above, already collects such information via online transaction processing. The additional data items can be accommodated in the merchant-backend communications by a variety of methods that will occur to those skilled in the art, including tag-linked data techniques used in financial transaction processing. In this way, a single data field can be added to conventional data communications to specify the data items to be included with the transaction information received from the merchant.

In the embodiment in FIG. 3, additional information such as a telephone number, SKU, shipping address, a reward credential, and other information such as the number of each SKU purchased, and so forth, can be sent to the backend 110 “up front” in a single authorization request message. This provides more information for the backend 110 than would be sent to the backend in a conventional purchase transaction. By providing more information “up front” with the authorization request message, additional referral processing is not likely to be needed. This eventually saves the consumer from a frustrating experience and makes it more likely that the transaction will proceed to completion.

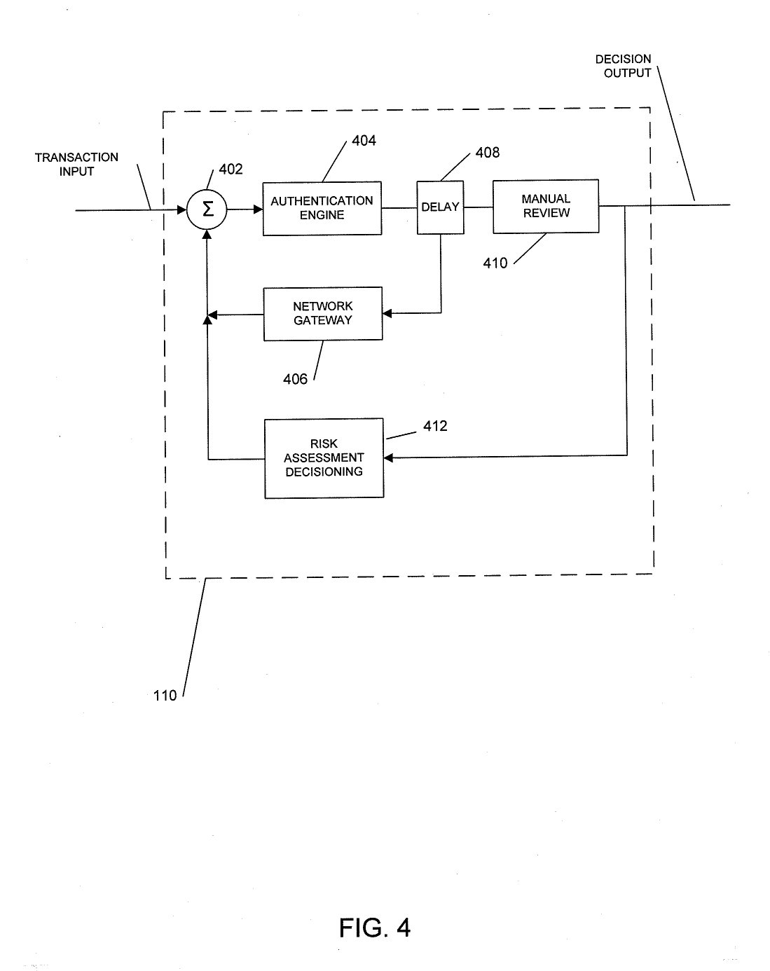

FIG. 4 is a block diagram depiction of the backend processing for online transactions in the FIG. 1 backend system 110, where all the consumer transaction information needed for an approval decision is received at the backend from the merchant. That is, no communication directly with the consumer is performed to resolve any online problems. In accordance with the increased information provided with the disclosed technique, such communication is not ordinarily needed to resolve any online problems.

The transactional input into the system 110 comprises the authorization request message received from the online merchant over a communications network (see FIG. 1) and its associated data. The summing block 402 represents the issuer processing of the transaction input information. The output of the summing block 402 is provided to an authentication engine 404 that may be operable at the issuer, at the payment processing network, or at both. The authentication engine provides an interface to data systems and the like for consumer data, account information, and the like. The authentication engine might need to communicate over a network gateway 406, to obtain needed data over secure communication. If desired, such communications (and any or all other backend processing) can take place after a delay time 408. Such delays might be useful, for example, if other processing is to take place in the interim. For example, a communication such as an email message or telephone call might be placed to the consumer's stated contact data a predetermined amount of time after the order is placed, for confirmation of identity. Such other interim processing might include shipping address lookup, checking the account history, and other risk assessment operations. If any transaction problems are identified, the transaction can be subjected to a manual review process 410, wherein a designated person or office conducts a review and comes to a conclusion about risk factors.

After the backend issuer authorization processing 402, the authentication processing 404, and the optional manual review 410, the system performs risk assessment decisioning 412 that produces an approval/decline outcome. This forms a feedback loop through the risk assessment decisioning 412 back to the issuer authorization processing 402. That is, the risk assessment outcome based on the additional information can be provided back to the authorization summing block 402 and the authentication engine 404, and communicated as a transaction decision output of the system 110 back to the merchant, to be conveyed to the consumer.

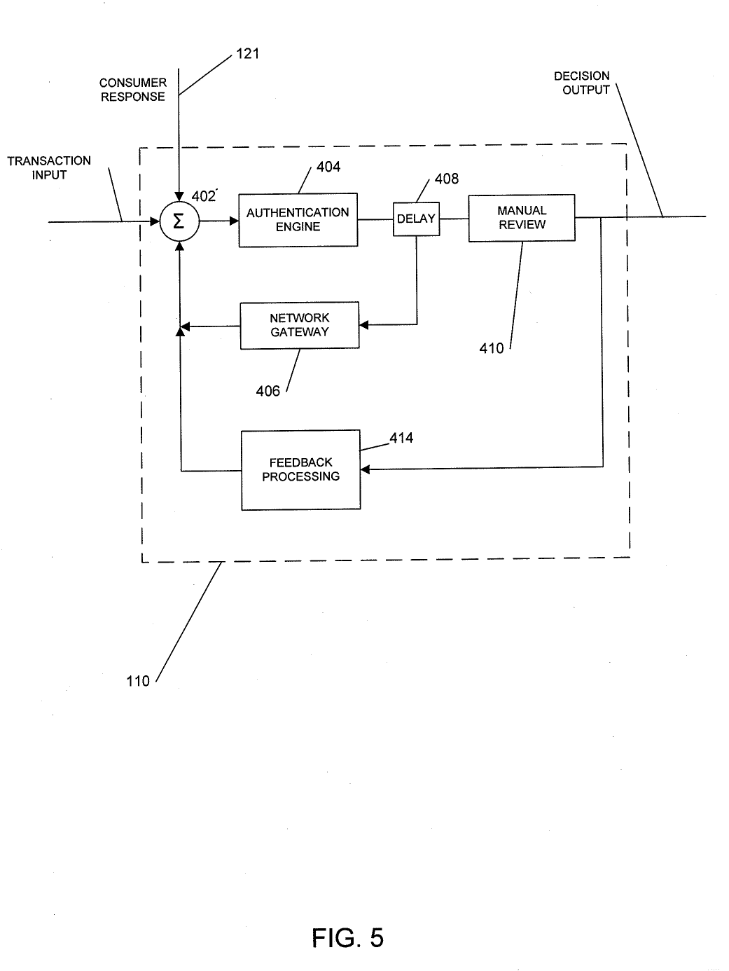

FIG. 5 is a block diagram depiction of the backend processing for online transactions in the FIG. 1 system, where at least a portion of the additional information and further additional information needed for an approval decision is requested directly from the consumer. The processing begins with the consumer transaction information received at the issuer authorization summing block 402. As noted above in connection with FIG. 4, output of the summing block is provided to the authentication engine 404 that oversees risk assessment, and a network gateway 406 provides an interface to data exchange for further additional information. The delay block 408 can provide delay in approval processing, as needed and as described above. A manual review 410 of the transaction is available as needed. In the FIG. 5 configuration, the issuer authorization processing 402 can receive additional consumer information directly from the consumer, such as responses to challenge questions, over additional communication lines 121. The directly received consumer information can be processed by a feedback processing block 414. For example, the challenge/response pairing might comprise a request from the acquirer/issuer for a password or reward credential (promotional code). If the consumer returns the correct password or code, then the transaction is permitted to proceed or is credited with the special reward or promotion. Details of such challenge processing can be better understood with reference to U.S. patent application Ser. No. 11/763,240 filed Jun. 14, 2007 entitled “Consumer Authentication System and Method” to A. Hammad and P. Faith, incorporated herein by reference.

The feedback processing 414 of FIG. 5 can be implemented using a variety of communication protocols and services. For example, the 3D-Secure Protocol is a technique provided by Visa USA that can provide suitable communications capability and security for the communications between the consumer and the backend. Similar secure communications may be implemented using a technique such as “Verified by Visa” (“VbV”) also provided by Visa USA.

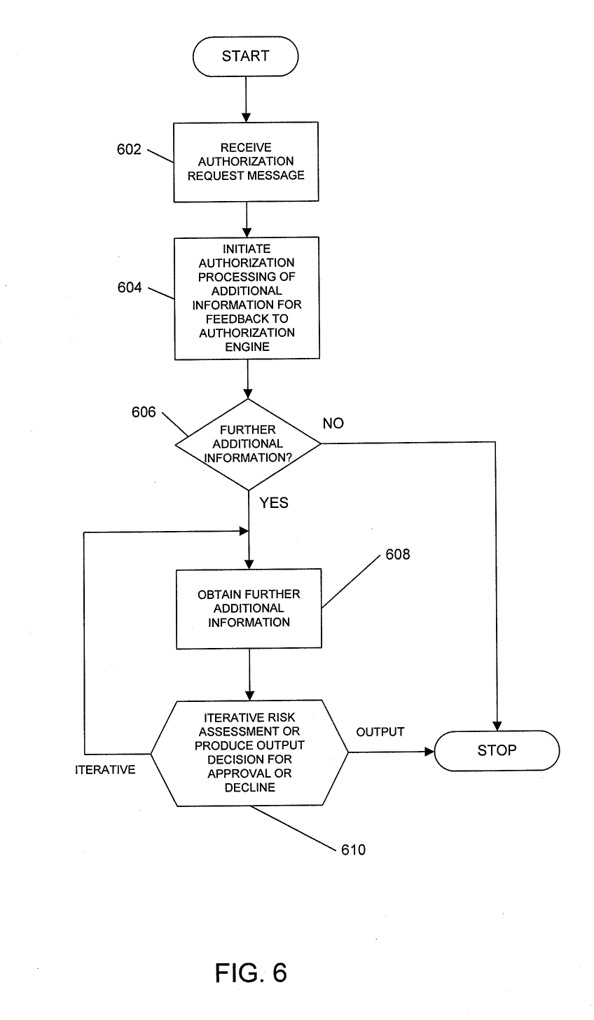

FIG. 6 is a flow diagram of the processing operations performed by the FIG. 1 system. In the first operation, indicated by the block 602, the online merchant submits an authorization request message for the consumer transaction. At the next block 604, the backend processing is initiated for authorization. The transaction risk is identified at the decision block 606 by determining if the additional information of the transaction has characteristics (transaction data) that indicates a risk level that is satisfactory. If no unsatisfactory transaction risk level is present, a negative outcome at the block 606, then the risk level is commensurate with approving the transaction, so that approval is granted and backend processing is concluded. Such approval conditions would hold, for example, if the additional information contained no contact information or shipping address that raised suspicions, or if the product identification number (e.g., SKU) was not a high risk item. Other “safe” considerations will be apparent to those skilled in the art. If an elevated transaction risk level is indicated, an affirmative outcome at the decision box 606, then the system determines that further additional information is needed. If there is an elevated risk level, then the system generates a request for further additional information, which is transmitted to the consumer. Processing proceeds to the next block 608.

As noted above, the additional information in the authorization request message includes information not ordinarily available to acquirer/issuer processing for current online transactions. Current online transactions are generally limited to the merchant identity, the consumer account identity, and the total amount of the transaction. In the disclosed technique, the additional information includes all the conventional data and also additional information. Whatever non-conventional information is received with the additional information of the authorization request message, more data can be requested and received as part of the further additional information. The combination of additional information and further additional information, in total, can include information such as merchant identity, consumer account information and account data, product quantity, transaction amount, consumer telephone number, transaction SKU data, consumer shipping address, optional reward credential information such as for special promotions, email address, computer network address, identification number of the consumer communication device, and optional challenge/response feedback from the consumer. Such information may be split between the additional information of the initial authorization request message in accordance with the invention and the requested further additional information.

At the block 608, the further additional information is obtained and then at block 610 the system performs risk assessment of the information. If the further additional information is sufficient to determine that the risk level is satisfactory (or that it is unsatisfactory), then an authorization approval (or decline) can be output from the system, as indicated in FIG. 6. If the risk assessment of the requested further additional information is inconclusive, then an iterative risk assessment process must be continued, in that another request for further additional information is provided to the consumer, and additional requests may be generated until a decline or approve decision is conclusively reached. The iterative assessment processing is indicated in FIG. 6 by the return of processing to the block 608, where the further additional information is received.

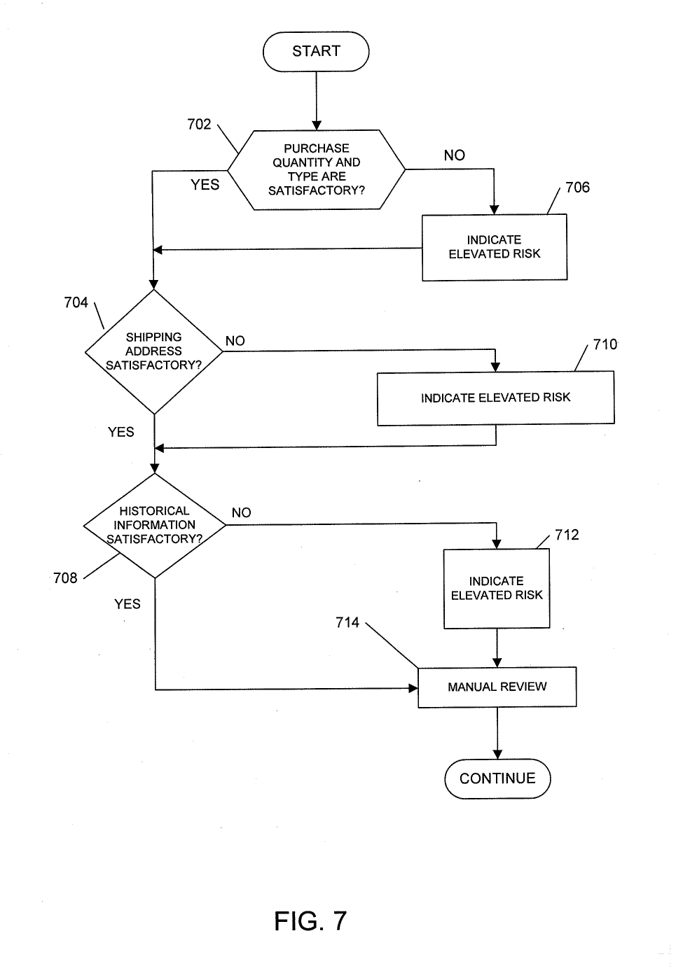

FIG. 7 is a flow diagram of an exemplary configuration of a system that performs the processing by the FIG. 4 configuration to assess the additional information of the authorization request message and any further additional information received. The processing of FIG. 7 is for a configuration in which no direct communication with the consumer takes place.

The FIG. 7 risk assessment processing can check a number of factors, so that problem resolution can be efficiently completed and does not need to take place in an iterative or serial fashion. The risk assessment processing begins at block 702, with a check of the purchase quantity and product type. If no elevated risk factors are present, an affirmative outcome at block 702, then processing proceeds to block 704. If risk factors are present, a negative outcome at block 702, then an elevated risk is indicated at box 706 and additional processing continues. An elevated risk is indicated, for example, by an excessive number of units purchased for the type of product, or by a purchase of a fraud-prevalent product type.

At block 704, the shipping address provided by the consumer is checked. If the shipping address is satisfactory, an affirmative outcome at block 704, then risk assessment processing continues unabated at block 708. An example of a satisfactory shipping address is one that matches the address of the consumer account. An address that is not satisfactory, a negative outcome at block 704, can include an address not previously seen on orders by the consumer, a shipping address a great distance from the consumer address such as in a foreign country, or an address that is in a fraud-prevalent location. A negative outcome at block 704 triggers an “elevated risk” indication for the transaction at block 710, and then risk assessment processing continues.

At block 708, historical information is considered. Such information can include historical data of the current account, comprising information relating to previous transactions by the consumer within a predetermined time period, to detect spending patterns that might be violated by the current transaction and thereby indicate potential fraud. The information at 708 can include other-account data, where the backend processing is aware of, and has access to, account data of the user for an account other than the account to which the current transaction is being applied. Such other account information may be provided by other vendors (e.g., credit agencies and services such as “Experian”® by Experian Group Limited). That is, the transaction being completed relates to a consumer account administered by an issuer, and the consumer historical information includes information relating to previous transactions by the consumer for at least one financial transaction account other than the consumer account.

If no historical data indicates elevated risk, an affirmative outcome at block 708, then risk assessment processing is concluded and transaction approval is indicated. If historical data shows that risk is not satisfactory, a negative outcome at block 708, then at block 712 the transaction is indicated as having elevated risk. At block 714, any indication of elevated risk from block 706, 710, or 712, will result in a manual review of the transaction. The risk assessment processing is then concluded, with the output dependent on the outcome of the manual review.

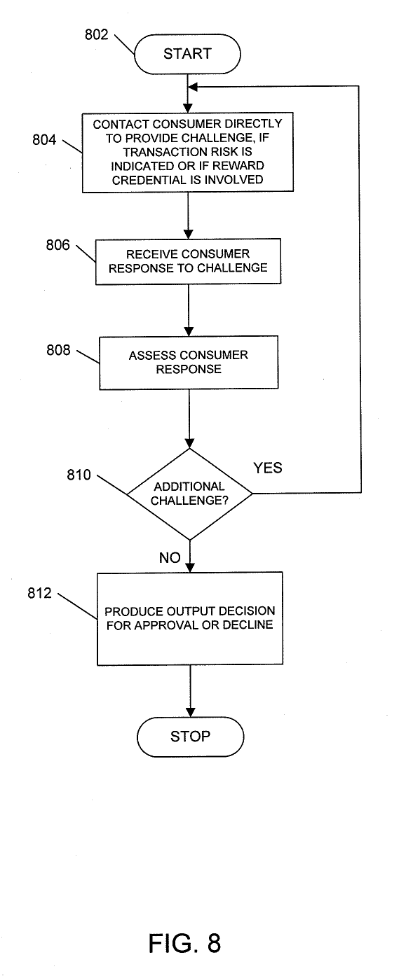

FIG. 8 is a flow diagram of authorization processing by the system wherein there is direct communication between the backend (issuer representative) and the consumer to complete an online transaction. Such processing is used, for example, in risk assessment that involves challenge/response or in connection with redemption of reward elements or promotional programs. Reward elements may comprise, for example, coupons for special offers or prizes in contests and the like.

A delay time can be applied, at the delay block 802, if appropriate to the transaction. Such delay may be desired, for example, if contact is to be made with the consumer by telephone, and a delay in making the call could reduce the chance that a fraudulent online consumer will be at the provided consumer telephone number. Similarly, an email contact might be more likely to uncover fraud if sent a time delay after the purchase transaction is submitted by the online consumer. In the next operation, at block 804, the online consumer is contacted directly to provide a challenge question or to request a reward credential or password. The challenge question is indicated, for example, if risk factors in the transaction data are identified. The challenge question in this scenario is similar to the referral processing that occurs in the “card present” situation. The reward credential may comprise a promotional code or special offer code or the like. In some circumstances, a password may be the preferred technique for increasing security and reducing fraud, even in the absence of risk factors.

At the block 806, the response from the consumer is received by the backend processing. The consumer response is received over a channel other than the purchase channel, because in the online purchase context, the purchase channel is already occupied or in use between the consumer and the online merchant. For example, the online consumer is likely at a computer connected to the Internet, and the transaction session ongoing between the consumer and the online merchant is likely occurring via the consumer browser and the Web site of the online merchant. That communication connection comprises the purchase channel. The challenge/response interchange (herein understood to include all scenarios with direct consumer-backend communication) then might take place via email communications, or in a pop-up window of the consumer browser, or via a telephone call to the consumer, all of which utilize a communication channel other than the purchase channel. The response received from the consumer is assessed at the block 810. The correct response will be known by the backend processing before the challenge message is sent to the consumer. When the response is received, it can be checked against the predetermined correct response. If the consumer response is correct, then approval is indicated.

More than one challenge/response pairing may be used. Such multiple pairings may be useful, for example, where multiple promotion codes are involved, or where an increased level of security is desired, or where the response to the first challenge is incorrect and a “second chance” challenge is provided. Multiple challenges might be issued, for example, on the notion that correct answers to multiple challenges is more likely to indicate low risk than a successful answer to a single challenge, which might be attributed to luck or happenstance. In addition, additional challenge/response pairings may be provided from third party vendors such as security vendors or the like, or other parties involved in the transaction processing sequence between the consumer and the issuer who grants approval.

If an additional challenge/response pairing is desired, an affirmative outcome at the decision block 810, then the next challenge/response pairing is provided and processing returns to the block 804. If no additional challenges are desired, a negative outcome at the decision block 810, then processing moves to the block 812, where the backend produces an output decision to approve or decline the request for approval of the online transaction.

FIG. 9 is a block diagram of an exemplary portable consumer device 900 for use in the FIG. 1 system. As noted above, the consumer 102 (FIG. 1) may complete a transaction using a portable consumer device having a memory. The portable consumer device may be in any suitable form for completing such a transaction. For example, suitable portable consumer devices can be hand-held and compact so that they can fit into a consumer's wallet and/or pocket (i.e., they may be pocket-sized). They may include smart cards, ordinary credit or debit cards (with a magnetic strip and without a microprocessor), keychain devices (such as the Speedpass™ commercially available from Exxon-Mobil Corp.), etc. Other examples of portable consumer devices include cellular phones, personal digital assistants (PDAs), pagers, payment cards, security cards, access cards, smart media, transponders, and the like. The portable consumer devices can also be debit devices (e.g., a debit card), credit devices (e.g., a credit card), or stored value devices (e.g., a stored value card).

An exemplary portable consumer device 932 in the form of a telephone may comprise a computer readable medium and a body as shown in FIG. 9 (FIG. 9 shows a number of components, and the portable consumer devices according to embodiments of the invention may comprise any suitable combination or subset of such components.) The computer readable medium (CRM) 932(b) may be present within the body 932(h), or may be detachable from it. The body 932(h) may be in the form a plastic substrate, housing, or other structure. The computer readable medium 932(b) may be a memory that stores data and may be in any suitable form including a magnetic stripe, a memory chip, etc. The memory preferably stores information such as financial information, transit information (e.g., as in a subway or train pass), access information (e.g., as in access badges), etc. Financial information may include information such as bank account information, bank identification number (BIN), credit or debit card number information, account balance information, expiration date, consumer information such as name, date of birth, etc. Any of this information may be transmitted by the portable consumer device 932.

Information in the memory may also be in the form of data tracks that are traditionally associated with credits cards. Such tracks include Track 1 and Track 2. Track 1 (“International Air Transport Association”) stores more information than Track 2, and contains the cardholder's name as well as account number and other discretionary data. This track is sometimes used by the airlines when securing reservations with a credit card. Track 2 (“American Banking Association”) is currently most commonly used. This is the track that is read by ATMs and credit card checkers. The ABA (American Banking Association) designed the specifications of this track and all world banks must abide by it. It contains the cardholder's account, encrypted PIN, plus other discretionary data.

The portable consumer device 932 may further include a contactless element 932(g), which is typically implemented in the form of a semiconductor chip (or other data storage element) with an associated wireless transfer (e.g., data transmission) element, such as an antenna. The contactless element 932(g) is associated with (e.g., embedded within) the portable consumer device 932 and data or control instructions transmitted via a cellular network may be applied to the contactless element 932(g) by means of a contactless element interface (not shown). The contactless element interface functions to permit the exchange of data and/or control instructions between the mobile device circuitry (and hence the cellular network) and an optional contactless element 932(g).

The contactless element 932(g) is capable of transferring and receiving data using a near field communications (“NFC”) capability (or near field communications medium) typically in accordance with a standardized protocol or data transfer mechanism (e.g., ISO 14443/NFC). Near field communications capability is a short-range communications capability, such as RFID, Bluetooth™, infra-red, or other data transfer capability that can be used to exchange data between the portable consumer device 932 and an interrogation device. Thus, the portable consumer device 932 is capable of communicating and transferring data and/or control instructions via both cellular network and near field communications capability.

The portable consumer device 932 may also include a processor 932(c) (e.g., a microprocessor) for processing the functions of the portable consumer device 932 and a display 932(d) to allow a consumer to see phone numbers and other information and messages. The portable consumer device 932 may further include input elements 932(e) to allow a consumer to input information into the device, a speaker 932(f) to allow the consumer to hear voice communication, music, etc., and a microphone 932(i) to allow the consumer to transmit her voice through the portable consumer device 932. The portable consumer device 932 may also include an antenna 932(a) for wireless data transfer (e.g., data transmission).

If the portable consumer device is in the form of a debit, credit, or smartcard, the portable consumer device may also optionally have features such as magnetic strips. Such devices can operate in either a contact or contactless mode.

An example of a portable consumer device 932″ in the form of a card is shown in FIG. 10, which shows a plastic substrate 932(m). A contactless element 932(o) for interfacing with an access device 934 may be present on or embedded within the plastic substrate 932(m). Consumer information 932(p) such as an account number, expiration date, and consumer name may be printed or embossed on the card. Also, a magnetic stripe 932(n) may also be on the plastic substrate 932(m).

As shown in FIG. 10, the portable consumer device 932″ may include both a magnetic stripe 932(n) and a contactless element 932(o). In other embodiments, both the magnetic stripe 932(n) and the contactless element 932(o) may be in the portable consumer device 932″. In other embodiments, either the magnetic stripe 932(n) or the contactless element 932(o) may be present in the portable consumer device 932″.

The payment processing system may include data processing subsystems, networks, and operations used to support and deliver authorization services, exception file services, and clearing and settlement services. An exemplary payment processing system may include VisaNet™. Payment processing systems such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

The payment processing network 116 (FIG. 1) may include one or more server computers. A server computer is typically a powerful computer or cluster of computers. For example, the server computer can be a large mainframe, a minicomputer cluster, or a group of servers functioning as a unit. In one example, the server computer may be a database server coupled to a Web server. The payment processing network 116 may use any suitable wired or wireless network, including the Internet.

The components of the backend processing 110, comprising the acquirer 112, issuer 114, and payment processing network 116, will include server computers that are configured to carry out the processing described herein. Thus, the processing components will have communication interfaces that will enable network communications such that the processing components can receive authorization request messages, thereby comprising a communication processor of the system. Similarly, suitable components of the backend processing will be configured so they can perform the risk assessment processing described herein, thereby comprising risk processors of the system. The risk assessment processing can be performed, for example, by server computers of the issuer 114 and the payment processing network 116.

The server computers in the payment processing network 116 may operate according to program instructions such that they will function in accordance with the operations described herein. That is, the server computers may receive authorization request messages with the additional information and may perform risk assessment processing as described herein and may authorize the transaction if risk level is satisfactory for approval. The server computers may obtain the program instructions from program product media, including optical media such as CD or DVD data discs with program instructions recorded thereon. The server computers can read the recorded instructions from the program product media and upon installation of such instructions, the servers will be able to operate in accordance with the description provided herein. Other program product media, such as flash memory devices and the like, can also be used. Other suitable media can be used by correspondingly equipped server computers, as will be known to those skilled in the art.

It should be apparent that the processing described above involving the consumer, the online merchant, and the backend all involves computing devices communicating over networks. As such, it should be understood that the computing devices may take many different configurations, including desktop and laptop computers, servers, smart phones, network-enabled personal digital assistants, and the like.

It should be understood that certain elements of the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The embodiments of the invention as described herein provide effective online referral processing protocols that will allow an issuer to recover information that is typically collected by merchants so that the issuer is more likely able to approve the transaction. The additional information obtained in the authorization request messages will, in most instances, provide the issuer with sufficient information to allow the issuer to approve the transaction. In this way, issuers should less frequently decline transactions that should otherwise be authorized and consumers will more likely be able to complete the intended transaction.

While certain exemplary embodiments have been described in detail and shown in the accompanying drawings, it is to be understood that such embodiments are merely illustrative of and not intended to be restrictive of the broad invention, and it is to be understood that the invention is not to be limited to the specific arrangements and constructions shown and described herein, and various other modifications may occur to those with ordinary skill in the art.

As used herein, the use of “a”, “an” or “the” is intended to mean “at least one”, unless specifically indicated to the contrary.

What is claimed is:

1. A computer-implemented method comprising:
receiving transaction input comprising an authorization request message for a transaction conducted over a communication network between a consumer and a merchant using a portable consumer device having a memory, wherein the authorization request message contains data comprising a transaction total amount for the transaction and additional information not stored in the memory of the portable consumer device and related to the transaction;
performing issuer authorization processing in response to the authorization request message data;
producing a decision output in response to the transaction input and the issuer authorization processing.

2. The method as defined in claim 1, further including:
performing risk assessment processing in accordance with the additional information, wherein performing risk assessment processing includes determining if the additional information in the authorization request message data indicates a risk level for the transaction that is commensurate with approving the transaction; and
authorizing the transaction if the risk assessment processing determines that the risk level for the transaction is satisfactory for approval.

3. The method as defined in claim 2, wherein the risk assessment processing is performed using consumer historical information, wherein the consumer historical information includes information relating to previous transactions by the consumer within a predetermined time period.

4. The method as defined in claim 3, wherein the transaction relates to a consumer account administered by an issuer, and the consumer historical information includes information relating to previous transactions by the consumer for at least one financial transaction account other than the consumer account.

5. The method as defined in claim 3, wherein the risk assessment processing is performed in response to consumer historical information that indicates a risk level for the transaction that is greater than a predetermined satisfactory level.

6. The method as defined in claim 1, wherein iterative risk assessment processing is performed if the determined risk level is greater than a predetermined risk level that is satisfactory for approval.

7. The method as defined in claim 6, wherein the iterative risk assessment processing comprises requesting further additional information directly from the consumer over a communication channel other than a purchase channel between the merchant and the consumer.

8. The method as defined in claim 7, wherein the further additional information is requested from the consumer in response to additional information that indicates a risk level that is greater than a predetermined satisfactory level.

9. The method as defined in claim 7, wherein the further additional information is requested from the consumer by calling a telephone number obtained from information associated with an account associated with the consumer.

10. The method as defined in claim 7, wherein the further additional information is requested from the consumer by communicating to an email address obtained from information associated with an account associated with the consumer.

11. The method as defined in claim 7, wherein the further additional information comprises a response to a predetermined challenge question.

12. The method as defined in claim 1, wherein the transaction is an Internet purchase transaction conducted with online communications using a computer network.

13. The method as defined in claim 1, wherein the additional information includes a product identification number for a product that is being purchased in the transaction.

14. The method as defined in claim 1, wherein the additional information includes a quantity of the product that is being purchased.

15. The method as defined in claim 1, wherein the additional information includes a shipping address provided by the consumer.

16. The method as defined in claim 1, wherein the additional information includes a telephone number provided by the consumer.

17. The method as defined in claim 1, wherein the additional information includes an email address provided by the consumer.

18. The method as defined in claim 1, wherein the additional information includes a network address of the consumer.

19. The method as defined in claim 1, wherein the additional information includes an identification number of a communication device from which the consumer is communicating over the communication network.

20. The method as defined in claim 19, wherein the identification number comprises a media access control address (MAC address) number of the communication device.

21. The method as defined in claim 1, wherein the additional information includes data relating to a promotional element.

22. A system comprising:
a communication processor that receives a transaction input comprising an authorization request message for a transaction conducted over a communication network between a consumer and a merchant using a portable consumer device having a memory, wherein the authorization request message contains data comprising a transaction total amount for the transaction and additional information not stored in the memory of the portable consumer device and related to the transaction; and
an authorization processor that performs issuer authorization processing in accordance with the authorization request message data; and
an authentication engine that produces a decision output in response to the transaction input and the issuer authorization processing.

23. The system as defined in claim 22, further including a risk processor that determines if the additional information in the authorization request message data indicates a risk level for the transaction that is commensurate with approving the transaction;
wherein the risk processor authorizes the transaction if the risk assessment processing determines that the risk level for the transaction is satisfactory for approval.

24. The system as defined in claim 23, wherein the risk assessment processing is performed using consumer historical information, wherein the consumer historical information includes information relating to previous transactions by the consumer within a predetermined time period.

25. The system as defined in claim 24, wherein the transaction relates to a consumer account administered by an issuer, and the consumer historical information includes information relating to previous transactions by the consumer for at least one financial transaction account other than the consumer account.

26. The system as defined in claim 24, wherein the risk assessment processing is performed in response to consumer historical information that indicates a risk level for the transaction that is greater than a predetermined satisfactory level.

27. The system as defined in claim 22, wherein iterative risk assessment processing is performed if the determined risk level is greater than a predetermined risk level that is satisfactory for approval.

28. The system as defined in claim 27, wherein the iterative risk assessment processing comprises requesting further additional information directly from the consumer over a communication channel other than a purchase channel between the merchant and the consumer.

29. The system as defined in claim 28, wherein the further additional information is requested from the consumer in response to additional information that indicates a risk level that is greater than a predetermined satisfactory level.

30. The system as defined in claim 28, wherein the further additional information is requested from the consumer by calling a telephone number obtained from information associated with an account associated with the consumer.

31. The system as defined in claim 28, wherein the further additional information is requested from the consumer by communicating to an email address obtained from information associated with an account associated with the consumer.

32. The system as defined in claim 28, wherein the further additional information comprises a response to a predetermined challenge question.

33. The system as defined in claim 22, wherein the transaction is an Internet purchase transaction conducted with online communications using a computer network.

34. The system as defined in claim 22, wherein the additional information includes an identification number of a communication device from which the consumer is communicating over the communication network.

35. The system as defined in claim 22, wherein the additional information includes a product identification number for a product that is being purchased in the transaction.

36. The system as defined in claim 22, wherein the additional information includes a quantity of the product that is being purchased.

37. A program product apparatus comprising:
a computer-readable medium for use in a computer system that reads program instructions recorded in the computer-readable medium; and
a program of computer-readable instructions executable by the computer system to perform operations comprising:
receiving transaction input comprising an authorization request message for a transaction conducted over a communication network between a consumer and a merchant using a portable consumer device having a memory, wherein the authorization request message contains data comprising a transaction total amount for the transaction and additional information not stored in the memory of the portable consumer device and related to the transaction;
performing issuer authorization processing in response to the authorization request message data;
producing a decision output in response to the transaction input and the issuer authorization processing.

38. The program product apparatus as defined in claim 37, wherein the operations performed by the computer system further include:
performing risk assessment processing in accordance with the additional information, wherein performing risk assessment processing includes determining if the additional information in the authorization request message data indicates a risk level for the transaction that is commensurate with approving the transaction; and
authorizing the transaction if the risk assessment processing determines that the risk level for the transaction is satisfactory for approval.

39. The program product apparatus as defined in claim 38, wherein the risk assessment processing is performed using consumer historical information, wherein the consumer historical information includes information relating to previous transactions by the consumer within a predetermined time period.

40. The program product apparatus as defined in claim 39, wherein the transaction relates to a consumer account administered by an issuer, and the consumer historical information includes information relating to previous transactions by the consumer for at least one financial transaction account other than the consumer account.

41. The program product apparatus as defined in claim 39, wherein the risk assessment processing is performed in response to consumer historical information that indicates a risk level for the transaction that is greater than a predetermined satisfactory level.

42. The program product apparatus as defined in claim 37, wherein iterative risk assessment processing is performed if the determined risk level is greater than a predetermined risk level that is satisfactory for approval.

43. The program product apparatus as defined in claim 42, wherein the iterative risk assessment processing comprises requesting further additional information directly from the consumer over a communication channel other than a purchase channel between the merchant and the consumer.

44. The program product apparatus as defined in claim 37, wherein the transaction is an Internet purchase transaction conducted with online communications using a computer network.

45. The program product apparatus as defined in claim 44, wherein the further additional information is requested from the consumer in response to additional information that indicates a risk level that is greater than a predetermined satisfactory level.

46. The program product apparatus as defined in claim 45, wherein the further additional information is requested from the consumer by calling a telephone number obtained from information associated with an account associated with the consumer.

47. The program product apparatus as defined in claim 37, wherein the transaction is an Internet purchase transaction conducted with online communications using a computer network.
